(19) United States
(12) Patent Application Publication
(10) Pub. No.: US 2013/0001399 A1
(43) Pub. Date: Jan. 3, 2013

(54) SOLID-STATE IMAGING DEVICE

(75) Inventor: Yoshitaka EGAWA, Kanagawa (JP)

(73) Assignee: Kabushiki Kaisha Toshiba, Tokyo (JP)

(21) Appl. No.: 13/421,316

(22) Filed: Mar. 15, 2012

(30) Foreign Application Priority Data
Jun. 28, 2011 (JP) 2011-142579

(51) Int. Cl. H01L 27/146

(52) U.S. Cl. 250/208.1

(57) ABSTRACT

According to one embodiment, a solid-state imaging device includes a pixel array unit that includes pixels configured to accumulate photo-electric converted charges and disposed in a matrix, and a vertical drive circuit that collectively drives the pixels for each line in an accumulating period of each pixel, thereby discharging charges which are accumulated at a predetermined or higher level in the pixels.

### CROSS-REFERENCE TO RELATED APPLICATIONS

This application is based upon and claims the benefit of priority from Japanese Patent Application No. 2011-142579, filed on Jun. 28, 2011; the entire contents of which are incorporated herein by reference.

### FIELD

The present embodiment relates generally to a solid-state imaging device.

### BACKGROUND

A photodiode may be saturated when intensive light is excessively incident on a CMOS image sensor. Saturated signal charges are radially diffused in an area, so that a saturated area expands (blooming). As a countermeasure against the above, there are cases using a method of discharging excessive signal charges through a detecting unit and a reset transistor by using a lateral type overflow structure in which a transistor for discharging the excessive signal charges is provided adjacent to the photodiode or by slightly opening a read gate. In this method, a saturation signal level of the photodiode may be lowered, such that an S/N is deteriorated under a bright environment.

### BRIEF DESCRIPTION OF THE DRAWINGS

FIG. 1 is a block diagram illustrating a schematic configuration of a solid-state imaging device according to a first embodiment;

FIGS. 2A to 2D are circuit diagrams illustrating examples of a configuration of a pixel PC of the solid-state imaging device of FIG. 1;

FIG. 3 is a timing chart illustrating a relation between an application timing of a read signal and a signal amount of a photodiode of the solid-state imaging device of FIG. 1;

FIG. 4 is a circuit diagram illustrating an example of a configuration of a decoder circuit 11 and gate latch circuits 12 and 13 of the solid-state imaging device of FIG. 1;

FIG. 5 is a circuit diagram illustrating an example of a configuration of a selector 14 and a level shifter 15 of the solid-state imaging device of FIG. 1;

FIG. 6 is a timing chart illustrating signal waveforms of the individual units of the decoder circuit 11 and the gate latch circuits 12 and 13 of the solid-state imaging device of FIG. 1;

FIG. 7 is a timing chart illustrating signal waveforms of the individual units of the selector 14 and the level shifter 15 of the solid-state imaging device of FIG. 1;

FIG. 8 is a circuit diagram illustrating an example of a configuration of a selector 14′ and a level shifter 15′ of a solid-state imaging device according to a second embodiment; and

FIG. 9 is a timing chart illustrating a relation between an application timing of a read signal and a signal amount of a photodiode of a solid-state imaging device according to a third embodiment.

### DETAILED DESCRIPTION

In general, according to a solid-state imaging device of an embodiment includes a pixel array unit and a vertical drive circuit. The pixel array unit includes pixels which accumulate photo-electric converted charges and are disposed in a matrix. The vertical drive circuit collectively drives the pixels for each of plural lines in an accumulating period of each pixel, thereby discharge a certain or higher level of charges which are accumulated in the pixels.

Hereinafter, solid-state imaging devices according to embodiments will be described with reference to the drawings. However, the present invention is not limited by those embodiments.

### First Embodiment

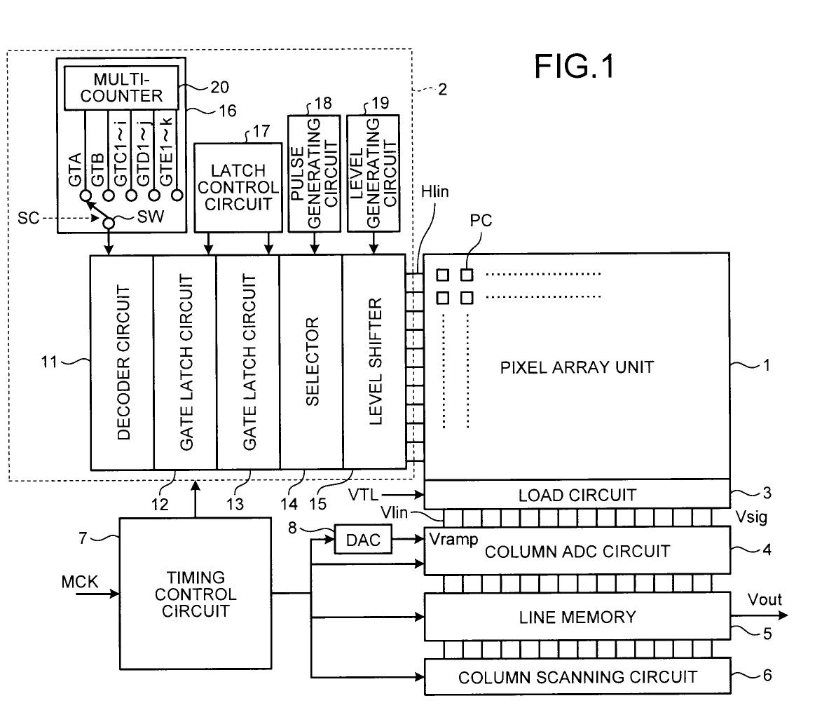

FIG. 1 is a block diagram illustrating a schematic configuration of a solid-state imaging device according to a first embodiment.

In FIG. 1, the solid-state imaging device includes a pixel array unit 1 including pixels PC that accumulate photo-electric converted charges and are disposed in a matrix in a row direction and a column direction, a vertical drive circuit 2 that scans pixels PC, which becomes read targets, in the vertical direction, a load circuit 3 that makes the potentials of vertical signal lines Vlin follow a signal read from the pixels PC, a column ADC circuit 4 that digitalizes a signal component of each pixel PC in CDS (correlated double sampling), a line memory 5 that stores the signal component of each pixel PC, which has been digitalized in the column ADC circuit 4, of one line, a column scanning circuit 6 that scans the stored signal of the line memory in the horizontal direction for reading the signal, a timing control circuit 7 that controls a reading or accumulating timing of each pixel PC, and a DA converter 8 that outputs a ramp signal Vramp to the column ADC circuit 4. To the timing control circuit 7, a master clock MCK is input.

Here, the vertical drive circuit 2 can drive the pixels for a plurality of lines collectively in the accumulating period of each pixel PC, thereby discharge the certain or higher level of charges which are accumulated in the pixel PC. Also, the vertical drive circuit 2 can drive the pixels PC for each line in a reading period, such that overall charges accumulated in the pixels PC are read.

The vertical drive circuit 2 includes a decoder circuit 11 that designates one selection row of the pixel array unit 1 for each line, a gate latch circuit 12 that stores data of the selection row designated by the decoder circuit 11, a gate latch circuit 13 that collectively stores the data of the selection row stored in the gate latch circuit 12, for each line, a selector 14 that selects a signal to drive the pixels PC, a level shifter 15 that controls the output level of the signal to drive the pixels PC, a decoder control circuit 16 that controls a row selecting timing of the decoder circuit 11, a latch control circuit 17 that controls a moving timing of the gate latch circuit 12 and 13, a pulse generating circuit 18 that controls a switching timing of the selector 14, and a level generating circuit 19 that sets the output level of the level shifter 15.

Here, the decoder control circuit 16 includes a multi-counter 20 including a plurality of sub-counters, and a switching unit SW that switches the sub-counters on the basis of a control signal SC to divide a horizontal scanning period. For example, one horizontal scanning period includes a shutter period TA, a reading period TB, and an accumulating period TX, and the accumulating period TX is divided into division periods TC, TD, and TE by the ½ and ¼ points of the accumulating period TX. In other words, the division period TC can be a period until the ½ point of the accumulating period TX, the division period TD can be a period from the ½ point to ¾ point of the accumulating period TX, and the division period TE can be a period from the ¾ point to ⅞ point of the accumulating period TX. In this case, the multi-counter 20 can include a sub-counter that outputs a count value GTA in the shutter period TA, a sub-counter that outputs a count value GTB in the reading period TB, and sub-counters that output count values GTC1 to GTCi (i is an integer of 2 or greater), GTD1 to GTDj (j is a positive integer), and GTE1 to GTEk (k is a positive integer) in the division periods TC, TD, and TE, respectively. Also, each of the count values GTA, GTB, GTC1 to GTCi, GTD1 to GTDj, and GTE1 to GTEk can be generated from n-bit counter data. The count values GTA, GTB, GTC1 to GTCi, GTD1 to GTDj, and GTE1 to GTEk can be incremented by 1 for each horizontal period from a state in which their initial values are deviated from each other, and return to 1 if the number of lines corresponding to one frame is reached, and be incremented by 1. Then, the switching unit SW can sequentially switch the count values GTA, GTB, GTC1 to GTCi, GTD1 to GTDj, and GTE1 to GTEk, and outputs the count values GTA, GTB, GTC1 to GTCi, GTD1 to GTDj, and GTE1 to GTEk to the decoder circuit 11, in one horizontal scanning period.

Also, the pixel array unit 1 includes horizontal control lines Hlin that control reading of the pixels PC and are disposed in the row direction, and the vertical signal lines Vlin that transmit a signal read from the pixels PC and are disposed in the column direction.

Further, in the shutter period TA, the pixels PC are driven for each line by the vertical drive circuit 2, such that charges accumulated in the pixels PC are discharged for each line. Next, in the accumulating period TX, the pixels PC are driven for each line by the vertical drive circuit 2, such that charges are accumulated in the pixels PC while the certain or higher level of charges accumulated in the pixels is discharged for each line. At this time, a read signal having a level lower than a read signal which is applied in a reading period TB of the pixels PC can be applied a plurality of times in each of the division periods TC, TD, and TE. At this time, a row to which a read signal is collectively applied in the division period TC is designated by the i number of count values GTC1 to GTCi, a row to which a read signal is collectively applied in the division period TD is designated by the j number of count values GTD1 to GTDj, and a row to which a read signal is collectively applied in the division period TE is designated by the k number of count values GTE1 to GTEk. Further, the levels of the read signals can decrease as the division periods TC, TD, and TE shorten. For example, if the levels of read signals of the shutter period TA and the reading period TB are set to 3 V, the level of the read signal of the division period TC can be set to 2 V, the level of the read signal of the division period TD can be set to 1.5 V, and the level of the read signal of the division period TE can be set to 1 V.

If the number of the levels of the read signals is set to D (D is a positive integer), it is preferable to set the number of lines when pixels PC of a plurality of liens are collectively driven in the accumulating period TX, to ½^{D} of the total number of accumulating lines or less.

Next, in the reading period TB, pixels PC are driven for each line by the vertical drive circuit 2, and a signal read from the pixels PC are transmitted to the column ADC circuit 4 through a vertical signal line Vlin. Here, in the load circuit 3, when a signal is read from the pixels PC, a source follower is configured between the pixels PC, such that the potential of the vertical signal line Vlin follows the signal read from the pixels PC.

Further, in the column ADC circuit 4, a reset level and a read level are sampled from the signal from each pixel PC, and a difference between the reset level and the read level (CDS) is obtained, such that the signal component of each pixel PC is digitalized and is output as an output signal Vout through the line memory 5.

Here, the pixels PC are collectively driven for each line in the accumulating period TX of each pixel PC, such that the certain or higher level of charges accumulated in the pixels PC is discharged. Therefore, it is possible to discharge excessive charges from the pixels PC with small charges accumulated in the pixels PC, and it becomes possible to reduce the blooming while suppressing a decrease in saturation signal level.

Further, the certain or higher level of charges accumulated in the pixels PC is collectively discharged for each line. Therefore, it is possible to discharge excessive charges from the same pixels PC a plurality of times, and even in a case where strong excessive light enters the CMOS image sensor, it becomes possible to effectively reduce the blooming.

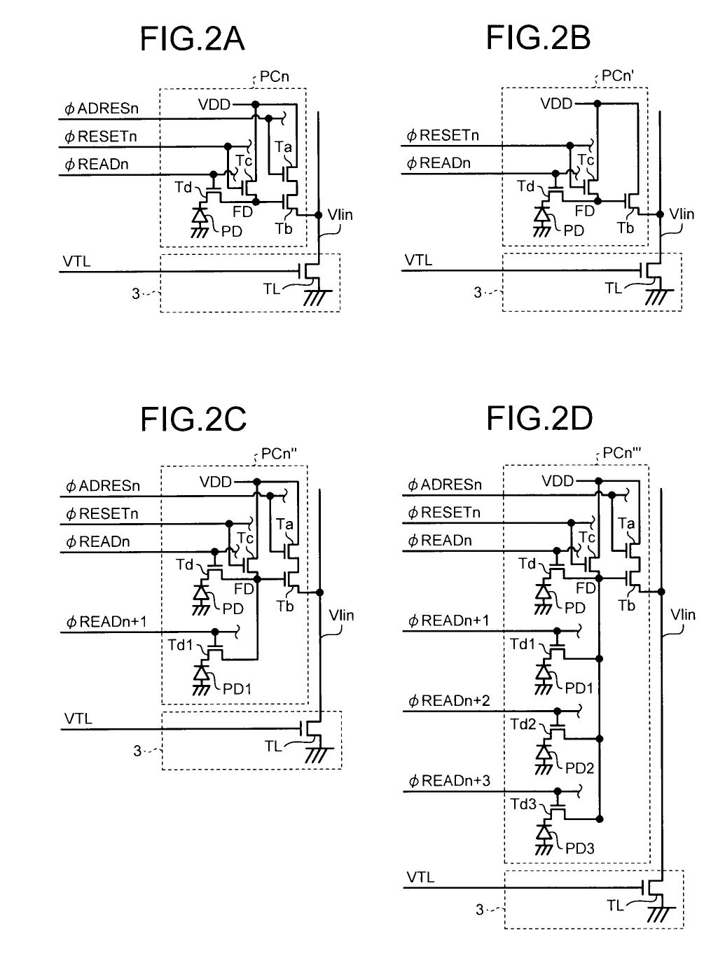

FIGS. 2A to 2D are circuit diagrams illustrating examples of a configuration of a pixel PC of the solid-state imaging device of FIG. 1.

In FIG. 2A, a pixel PCn includes a photodiode PD, a row selecting transistor Ta, an amplifying transistor Tb, a reset transistor Tc, and a read transistor Td. Further, as a detection node, floating diffusion FD is formed at a connection node of the amplifying transistor Tb, the reset transistor Tc, and the read transistor Td.

Furthermore, a source of the read transistor Td is connected to the photodiode PD, and a read signal ΦREADn is input to a gate of the read transistor Td. Also, a source of the reset transistor Tc is connected to a drain of the read transistor Td, a reset signal ΦRESETn is input to a gate of the reset transistor Tc, and a drain of the reset transistor Tc is connected to a power supply potential VDD. Further, a row selecting signal ΦADRESn is input to a gate of the row selecting transistor Ta, and a drain of the row selecting transistor Ta is connected to the power supply potential VDD. Furthermore, a source of the amplifying transistor Tb is connected to a vertical signal line Vlin, the gate of the amplifying transistor Tb is connected to drain of the read transistor Td, and the drain of the amplifying transistor Tb is connected to the source of the row selecting transistor Ta.

In the load circuit 3, a load transistor TL is provided for each column. Further, a drain of the load transistor TL is connected to a vertical signal line Vlin, and a bias voltage VTL is input to a gate of the load transistor TL.

The horizontal control lines Hlin of FIG. 1 can transmit the read signal ΦREADn, the reset signal ΦRESETn and the row selecting signal ΦADRESn to the pixels PC for each row.

In FIG. 2B, a pixel PCn′ has the same configuration as the pixel PCn of FIG. 2A, except row selecting transistor Ta. In the pixel PCn′, a signal VDD is configured to be capable of switching between the power supply potential VDD and a ground potential.

Then, in a non-selected row, the potential of the floating diffusion FD is set to the ground potential through the reset transistor Tc, and the amplifying transistor Tb is turned off. Meanwhile, in a selected row, the floating diffusion FD is set to the power supply potential VDD through the reset transistor Tc, and the amplifying transistor Tb is turned off.

In FIG. 2C, a pixel PCn″ additionally includes a read transistor Td1 and a photodiode PD1, as compared to the pixel PCn. Consequently, the photodiodes PD and PD1 corresponding to two pixels are provided. Further, one amplifying transistor Tb is commonly used by two pixels of the photodiodes PD and PD1.

In FIG. 2D, a pixel PCn′″ additionally includes read transistors Td1 to Td3 and photodiodes PD1 to PD3, as compared to the pixel PCn. Consequently, the photodiodes PD and PD1 to PD3 corresponding to four pixels are provided. Further, one amplifying transistor Tb is commonly used by four pixels of photodiodes PD and PD1 to PD3.

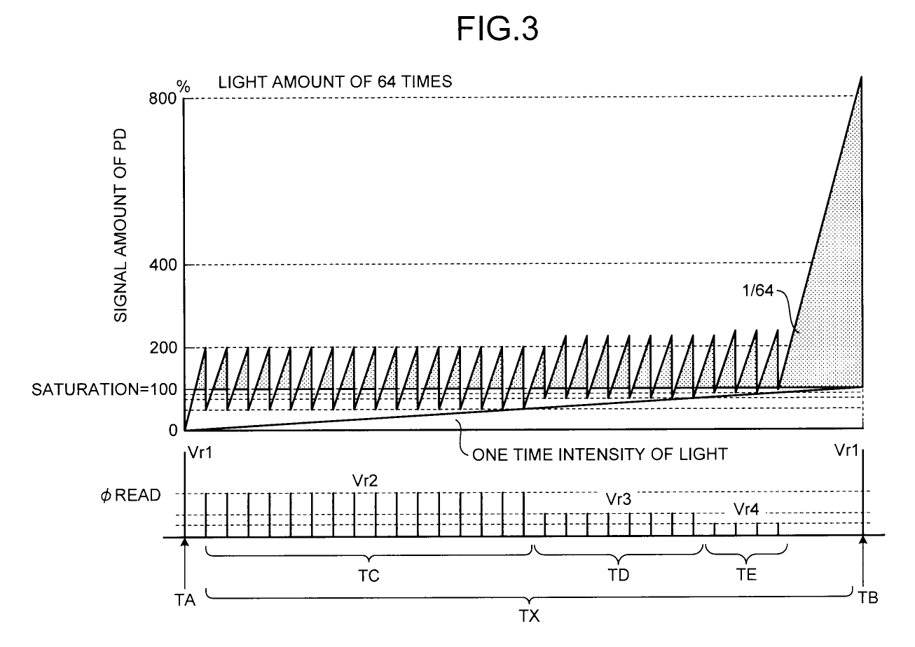

FIG. 3 is a timing chart illustrating a relation between an application timing of a read signal and a signal amount of a photodiode of the solid-state imaging device of FIG. 1.

In FIG. 3, in the shutter period TA, the reset signal ΦRESETn is applied to the reset transistor Tc of FIG. 2A and the read signal ΦREADn is applied to the read transistor Td, whereby signal charge of the photodiode PD is discharged. At this time, the read voltage of the read signal ΦREADn is set to Vr1.

In the accumulating period TX, the reset signal ΦRESETn is regularly applied to the reset transistor Tc of FIG. 2A, and the read signal ΦREADn is regularly applied to the read transistor Td, whereby excessive signal charge of the photodiode PD is discharged. At this time, in the division period TC, the read voltage of the read signal ΦREADn is set to Vr2, and in the division period TD, the read voltage of the read signal ΦREADn is set to Vr3, and in the division period TE, the read voltage of the read signal ΦREADn is set to Vr4.

The read voltage Vr2 can be set as a voltage to read a signal of about 50% or less of saturation from the photodiode PD. The read voltage Vr3 can be set as a voltage to read a signal of about 25% or less of saturation from the photodiode PD. The read voltage Vr4 can be set as a voltage to read a signal of about 12.5% or less of saturation from the photodiode PD.

For example, in the division period TC, the read voltage Vr2 can be collectively applied to 16 lines, and in the division period TD, the read voltage Vr3 can be collectively applied to 8 lines, and in the division period TE, the read voltage Vr4 can be collectively applied to 4 lines.

Accordingly, it is possible to discharge signal charges of the saturation signal or greater a plurality of times in the pixels PC during the accumulating period TX, and only a signal of a triangular gray portion after the division period TE becomes a blooming amount. Therefore, it is possible to reduce the blooming amount to about 1/64 as compared to a case where excessive charges are not discharged from the pixels PC in the accumulating period TX, and, for example, it is possible to reduce the excessive signal charges spread in 64 pixels, to charge corresponding to one pixel.

Further, the level of the read signal ΦREADn decreases as the division periods TC, TD, and TE shorten. Therefore, it is possible to prevent a decrease in the saturation signal level of the photodiode PD, and it is possible to prevent S/N deterioration in a bright environment.

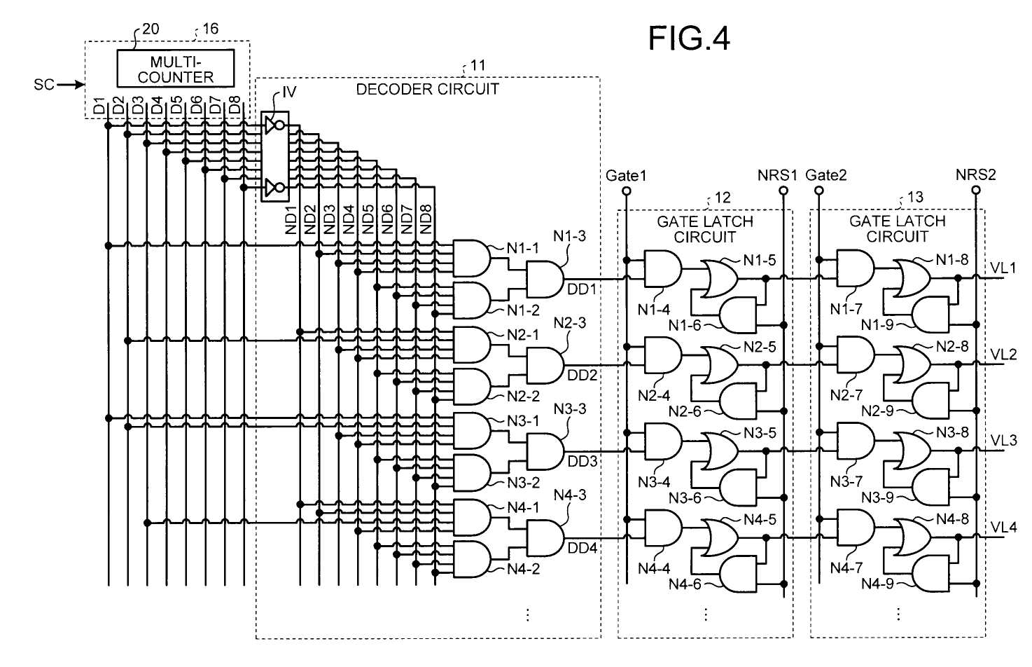

FIG. 4 is a circuit diagram illustrating an example of a configuration of a decoder circuit 11 and gate latch circuits 12 and 13 of the solid-state imaging device of FIG. 1. In the example of FIG. 4, the decoder circuit 11 and the gate latch circuits 12 and 13 illustrate a configuration corresponding to four lines of the pixel array unit 1 of FIG. 1.

FIG. 4 illustrates an example in which each counter of the multi-counter 20 outputs 8-bit data D1 to D8. At this time, each counter of the multi-counter 20 can select 2⁸=256 lines. Further, the decoder circuit 11 includes inverters IV that invert the data D1 to D8, respectively, and AND circuits N1-1 to N1-3, N2-1 to N2-3, N3-1 to N3-3, and N4-1 to N4-3.

The gate latch circuit 12 includes AND circuits N1-4, N1-6, N2-4, N2-6, N3-4, N3-6, N4-4, and N4-6, and OR circuits N1-5, N2-5, N3-5, and N4-5. The gate latch circuit 13 includes AND circuits N1-7, N1-9, N2-7, N2-9, N3-7, N3-9, N4-7, and N4-9, and OR circuits N1-8, N2-8, N3-8, and N4-8.

Here, the AND circuits N1-1 to N1-4, N1-6, N1-7, and N1-9 and the OR circuits N1-5 and N1-8 can correspond to a first line, the AND circuits N2-1 to N2-4, N2-6, N2-7, and N2-9 and the OR circuits N2-5 and N2-8 can correspond to a second line, the AND circuits N3-1 to N3-4, N3-6, N3-7, and N3-9 and the OR circuits N3-5 and N3-8 can correspond to a third line, and the AND circuits N4-1 to N4-4, N4-6, N4-7, and N4-9 and the OR circuits N4-5 and N4-8 can correspond to a fourth line.

Further, whenever a value of each counter of the multi-counter 20 is counted up by 1 in every horizontal period, the number of selected lines can be incremented by 1. At this time, it is assumed that the first line is designated by the data D1 to D8 of (1, 0, 0, 0, 0, 0, 0, 0, 0), the second line is designated by the data D1 to D8 of (0, 1, 0, 0, 0, 0, 0, 0, 0), the third line is designated by the data D1 to D8 of (1, 1, 0, 0, 0, 0, 0, 0, 0), the fourth line is designated by the data D1 to D8 of (0, 0, 1, 0, 0, 0, 0, 0, 0).

In this case, the data D1 and inverted data ND2 to ND8 are input to the AND circuits N1-1 and N1-2, the data D2 and inverted data ND1 and ND3 to ND8 are input to the AND circuits N2-1 and N2-2, the data D1 and D2 and inverted data ND3 to ND8 are input to the AND circuits N3-1 and N3-2, and the data D3 and inverted data ND1, ND2, and ND4 to ND8 are input to the AND circuits N4-1 and N4-2.

Outputs of the AND circuits N1-1 and N1-2 are input to the AND circuit N1-3, outputs of the AND circuits N2-1 and N2-2 are input to the AND circuit N2-3, outputs of the AND circuits N3-1 and N3-2 are input to the AND circuit N3-3, and outputs of the AND circuits N4-1 and N4-2 are input to the AND circuit N4-3.

A gate signal Gate1 is input to one-side input terminals of the AND circuits N1-4, N2-4, N3-4, and N4-4, and outputs of the AND circuits N1-3, N2-3, N3-3, and N4-3 are input to the other input terminals of the AND circuits N1-4, N2-4, N3-4, and N4-4, respectively.

Outputs of the AND circuits N1-4, N2-4, N3-4, and N4-4 are input to one-side input terminals of the OR circuits N1-5, N2-5, N3-5, and N4-5, respectively, and outputs of the AND circuits N1-6, N2-6, N3-6, and N4-6 are input to the other input terminals of the OR circuits N1-5, N2-5, N3-5, and N4-5, respectively.

Outputs of the OR circuits N1-5, N2-5, N3-5, and N4-5 are input to one-side input terminals of the AND circuits N1-6, N2-6, N3-6, and N4-6, respectively, and a reset signal NRS1 is input to the other input terminals of the AND circuits N1-6, N2-6, N3-6, and N4-6.

A gate signal Gate2 is input to one-side input terminals of the AND circuits N1-7, N2-7, N3-7, and N4-7, and outputs of the OR circuits N1-5, N2-5, N3-5, and N4-5 are input to the other input terminals of the AND circuits N1-7, N2-7, N3-7, and N4-7, respectively.

Outputs of the AND circuits N1-7, N2-7, N3-7, and N4-7 are input to one-side input terminals of the OR circuits N1-8, N2-8, N3-8, and N4-8, respectively, and outputs of the AND circuits N1-9, N2-9, N3-9, and N4-9 are input to the other input terminals of the OR circuits N1-8, N2-8, N3-8, and N4-8, respectively.

Outputs of the OR circuits N1-8, N2-8, N3-8, and N4-8 are input to one-side input terminals of the AND circuits N1-9, N2-9, N3-9, and N4-9, respectively, and a reset signal NRS2 is input to the other input terminals of the AND circuits N1-9, N2-9, N3-9, and N4-9.

In the example of FIG. 4, the configuration using the AND circuits and the OR circuits has been described; however, other logic circuits may be used.

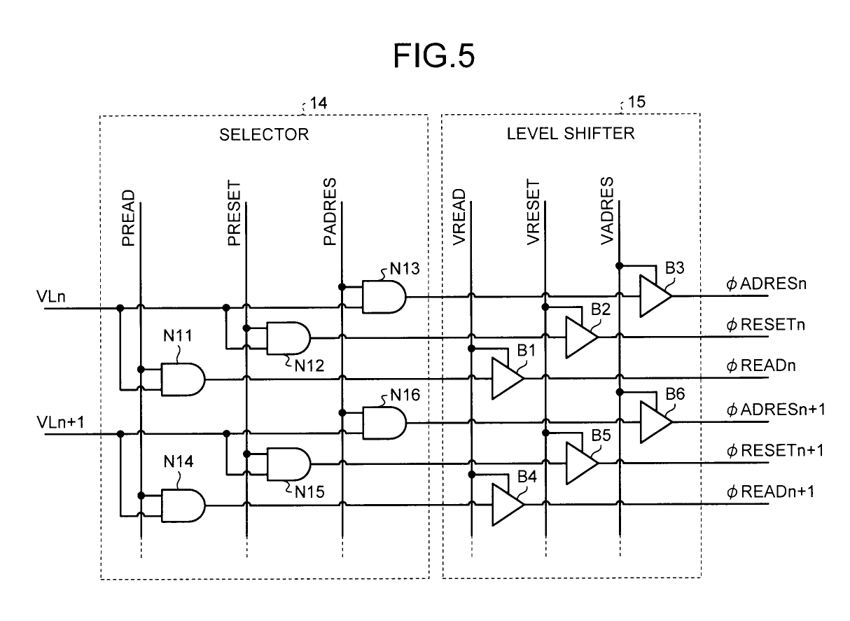

FIG. 5 is a circuit diagram illustrating an example of a configuration of a selector 14 and a level shifter 15 of the solid-state imaging device of FIG. 1. In the example of FIG. 5, the selector 14 and the level shifter 15 illustrate a configuration corresponding to 2 lines of the pixel array unit 1 of FIG. 1.

In FIG. 5, the selector 14 includes AND circuits N11 to N16, and the level shifter 15 includes buffers B1 to B6. Here, the AND circuits N11 to N13 and the buffers B1 to B3 correspond to an n-th line (n is a positive integer), and AND circuits N14 to N16 and the buffers B4 to B6 correspond to an (n+1)-th line.

Further, a read instruction signal PREAD is input to one-side input terminals of the AND circuits N11 and N14, a reset instruction signal PRESET is input to one-side input terminals of the AND circuits N12 and N15, and a row selection instruction signal PADRES is input to one-side input terminals of the AND circuits N13 and N16. Further, a line designation signal VLn of the n-th line of the gate latch circuit 13 is input to the other input terminals of the AND circuits N11 to N13, and a line designation signal VLn+1 of the (n+1)-th line of the gate latch circuit 13 is input to the other input terminals of the AND circuits N14 to N16.

An output of the AND circuit N11 is input to the buffer B1, an output of the AND circuit N12 is input to the buffer B2, an output of the AND circuit N13 is input to the buffer B3, an output of the AND circuit N14 is input to the buffer B4, an output of the AND circuit N15 is input to the buffer B5, and an output of the AND circuit N16 is input to the buffer B6. Further, a read voltage VREAD is supplied to the buffers B1 and B4, a reset voltage VRESET is supplied to the buffers B2 and B5, and a row selection voltage VADRES is supplied to the buffers B3 and B6.

Further the value of the read voltage VREAD can vary in the accumulating period TX with respect to the shutter period TA and the reading period TB. For example, if the read voltage VREAD of the shutter period TA and the reading period TB is Vr1, the read voltage VREAD of the division period TC is Vr2, the read voltage VREAD of the division period TD is Vr3, and the read voltage VREAD of the division period TE is Vr4, the read voltage Vr1 can be 3 V, the read voltage Vr2 can be 2 V, the read voltage Vr3 can be 1.5 V, and the read voltage Vr4 can be 1 V. Further, the reset voltage VRESET and the row selection voltage VADRES can be set to about 3.3 V, for example.

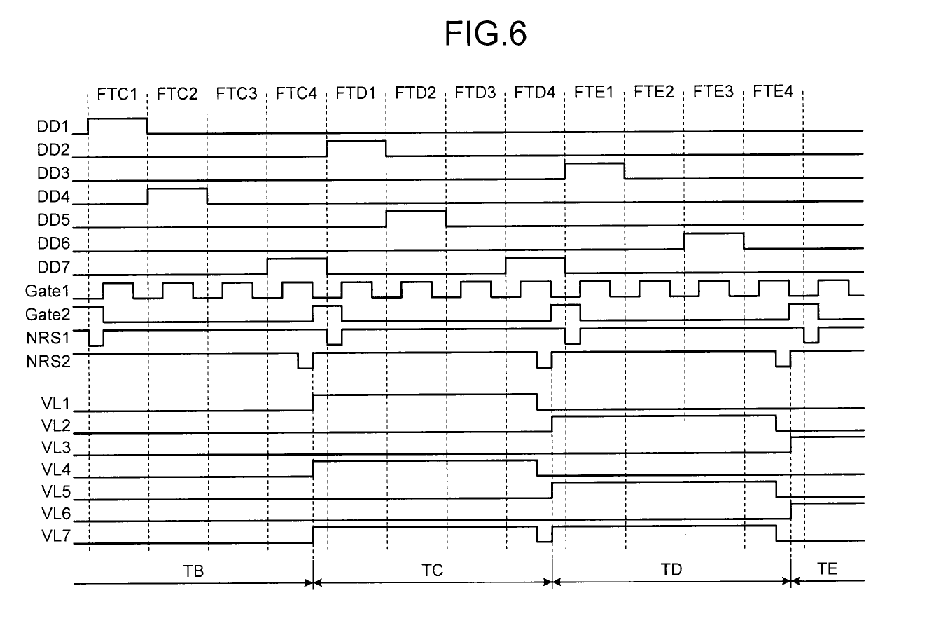

FIG. 6 is a timing chart illustrating signal waveforms of the individual units of the decoder circuit 11 and the gate latch circuits 12 and 13 of the solid-state imaging device of FIG. 1. The example of FIG. 6 illustrates a timing chart corresponding to 7 lines of the pixel array unit 1 of FIG. 1. Further, the example of FIG. 6 illustrates a method of collectively applying the read voltage Vr2 to four lines at most in the division period TC, collectively applying the read voltage Vr3 to four lines at most in the division period TD, and collectively applying the read voltage Vr4 to four lines at most in the division period TE. At this time, the multi-counter 20 of FIG. 1 can generate count values GTA, GTB, GTC1 to GTC4, GTD1 to GTD4, and GTE1 to GTE4 in one horizontal scanning period. Further, the division period TC is divided into fine division periods FTC1 to FTC4, the division period TD is divided into fine division periods FTD1 to FTD4, and the division period TE is divided into fine division periods FTE1 to FTE4. Furthermore, the gate signal Gate1 can rise for each of the fine division periods FTC1 to FTC4, FTD1 to FTD4, and FTE1 to FTE4, and the gate signal Gate2 can rise for each division period. The reset signals NRS1 and NRS2 can fall for each division period.

In FIG. 6, according to the shutter period TA, the reading period TB, and the division periods TC, TD, and TE, the counter values GTA, GTB, GTC1 to GTC4, GTD1 to GTD4, and GTE1 to GTE4 are sequentially selected through the switching unit SW, such that the data D1 to D8 are output in the decoder circuit 11. Further, in the decoder circuit 11 of FIG. 4, the data D1 to D8 are inverted by the inverters IV such that the inverted data ND1 to ND 8 are generated, and decoder outputs DD1 to DD7 are generated based on the data D1 to D8 and the inverted data ND1 to ND8, and are output to the gate latch circuit 12.

For example, in the fine division period FTC1, if the count value GTC1 is selected, such that the first line is designated by the count value GTC1, the decoder output DD1 is output to the gate latch circuit 12. Then, the latch circuits of all rows of the gate latch circuit 12 are reset by the reset signal NRS1, and then the gate signal Gate1 rises. Therefore, the decoder output DD1 is stored in the latch circuits of the first line of the gate latch circuit 12. The latch circuits of the first line of the gate latch circuit 12 can be configured by the OR circuit N1-5 and the AND circuit N1-6 of FIG. 4.

In the fine division period FTC2, if the count value GTC2 is selected, such that the fourth line is designated by the count value GTC2, the decoder output DD4 is output to the gate latch circuit 12. Then, the gate signal Gate1 rises. Therefore, the decoder output DD4 is stored in the latch circuits of the fourth line of the gate latch circuit 12. The latch circuits of the fourth line of the gate latch circuit 12 can be configured by the OR circuit N4-5 and the AND circuit N4-6 of FIG. 4.

In the fine division period FTC4, if the count value GTC4 is selected, such that the seventh line is designated by the count value GTC4, the decoder output DD7 is output to the gate latch circuit 12. Then, the gate signal Gate1 rises. Therefore, the decoder output DD7 is stored in the latch circuits of the seventh line of the gate latch circuit 12.

Next, the latch circuits of all rows of the gate latch circuit 13 are reset by the reset signal NRS2, and then the gate signal Gate 2 rises. Therefore, outputs of the latch circuits of the first, fourth, and seventh lines of the gate latch circuit 12 are stored in the latch circuits of the first, fourth, and seventh lines of the gate latch circuit 13, respectively, and line designation signals VL1, VL4, and VL7 of the first, fourth, and seventh lines are output at the same time. The latch circuits of the first line of the gate latch circuit 13 can be configured by the OR circuit N1-8 and the AND circuit N1-9 of FIG. 4, and the latch circuits of the fourth line of the gate latch circuit 13 can be configured by the OR circuit N4-8 and the AND circuit N4-9 of FIG. 4

Next, in the selector 14 of FIG. 1, (first, fourth, and seventh) lines designated by the line designation signals VL1, VL4, and VL7 are collectively selected in the division period TC, and in the level shifter 15, the read voltage of the read signal ΦREADn is set to Vr2. Then, the reset signal ΦRESETn is collectively applied to the reset transistors Tc of the pixels PC of the first, fourth, and seventh rows, and the read signal ΦREADn is collectively applied to the read transistors Td of the pixels PC of the first, fourth, and seventh rows, such that the excessive signal load of the photodiodes PD of the pixels PC of the first, fourth, and seventh rows are collectively discharged.

Also, in the fine division period FTD1, if the count value GTD1 is selected, such that the second line is designated by the count value GTD1, the decoder output DD2 is output to the gate latch circuit 12. Then, the latch circuits of all rows of the gate latch circuit 12 are reset by the reset signal NRS1, and then the gate signal Gate1 rises. Therefore, the decoder output DD2 is stored in the latch circuits of the second line of the gate latch circuit 12. The latch circuits of the second line of the gate latch circuit 12 can be configured by the OR circuit N2-5 and the AND circuit N2-6 of FIG. 4.

In the fine division period FTD2, if the count value GTD2 is selected, such that the fifth line is designated by the count value GTD2, the decoder output DD5 is output to the gate latch circuit 12. Then, the gate signal Gate1 rises. Therefore, the decoder output DD5 is stored in the latch circuits of the fifth line of the gate latch circuit 12.

In the fine division period FTD4, if the count value GTD4 is selected, such that the seventh line is designated by the count value GTD4, the decoder output DD7 is output to the gate latch circuit 12. Then, the gate signal Gate1 rises. Therefore, the decoder output DD7 is stored in the latch circuits of the seventh line of the gate latch circuit 12.

Next, the latch circuits of all rows of the gate latch circuit 13 are reset by the reset signal NRS2, and then the gate signal Gate2 rises. Therefore, outputs of the latch circuits of the second, fifth, and seventh lines of the gate latch circuit 12 are stored in the latch circuits of the second, fifth, and seventh lines of the gate latch circuit 13 and line designation signals VL2, VL5, and VL7 of the second, fifth, and seventh lines are output at the same time. The latch circuits of the second line of the gate latch circuit 13 can be configured by the OR circuit N2-8 and the AND circuit N2-9 of FIG. 4.

Next, in the selector 14 of FIG. 1, (second, fifth, and seventh) lines designated by the line designation signals VL2, VL5, and VL7 are collectively selected in the division period TD, and in the level shifter 15, the read voltage of the read signal ΦREADn is set to Vr3. Then, the reset signal ΦRESETn is collectively applied to the reset transistors Tc of the pixels PC of the second, fifth, and seventh rows, and, at the same time, the read signal ΦREADn is collectively applied to the read transistors Td of the pixels PC of the second, fifth, and seventh rows, such that the excessive signal load of the photodiodes PD of the pixels PC of the second, fifth, and seventh rows are collectively discharged.

Also, in the fine division period FTE1, if the count value GTE1 is selected, such that the third line is designated by the count value GTE1, the decoder output DD3 is output to the gate latch circuit 12. Then, the latch circuits of all rows of the gate latch circuit 12 are reset by the reset signal NRS1, and then the gate signal Gate1 rises. Therefore, the decoder output DD3 is stored in the latch circuits of the third line of the gate latch circuit 12. The latch circuits of the third line of the gate latch circuit 12 can be configured by the OR circuit N3-5 and the AND circuit N3-6 of FIG. 4.

In the fine division period FTE3, if the count value GTE3 is selected, such that the sixth line is designated by the count value GTE3, the decoder output DD6 is output to the gate latch circuit 12. Then, the gate signal Gate1 rises. Therefore, the decoder output DD6 is stored in the latch circuits of the sixth line of the gate latch circuit 12.

Next, the latch circuits of all rows of the gate latch circuit 13 are reset by the reset signal NRS2, and then the gate signal Gate2 rises. Therefore, outputs of the latch circuits of the third and sixth lines of the gate latch circuit 12 are stored in the latch circuits of the third and sixth lines of the gate latch circuit 13 and line designation signals VL3 and VL6 of the third and sixth lines are output at the same time. The latch circuits of the third line of the gate latch circuit 13 can be configured by the OR circuit N3-8 and the AND circuit N3-9 of FIG. 4.

Next, in the selector 14 of FIG. 1, (third and sixth) lines designated by the line designation signals VL3 and VL6 are collectively selected in the division period TE, and in the level shifter 15, the read voltage of the read signal ΦREADn is set to Vr4. Then, the reset signal ΦRESETn is applied to the reset transistors Tc of the pixels PC of the third and sixth rows, and the read signal ΦREADn is collectively applied to the read transistors Td of the pixels PC of the third and sixth rows, such that the excessive signal load of the photodiodes PD of the pixels PC of the third and sixth rows are collectively discharged.

Here, the gate latch circuit 13 is provided at the next stage of the gate latch circuit 12. Therefore, if a plurality of lines to be discharged in the next TD period is selected while signal charges of a plurality of lines are discharged in a TC period, high speed operation is possible.

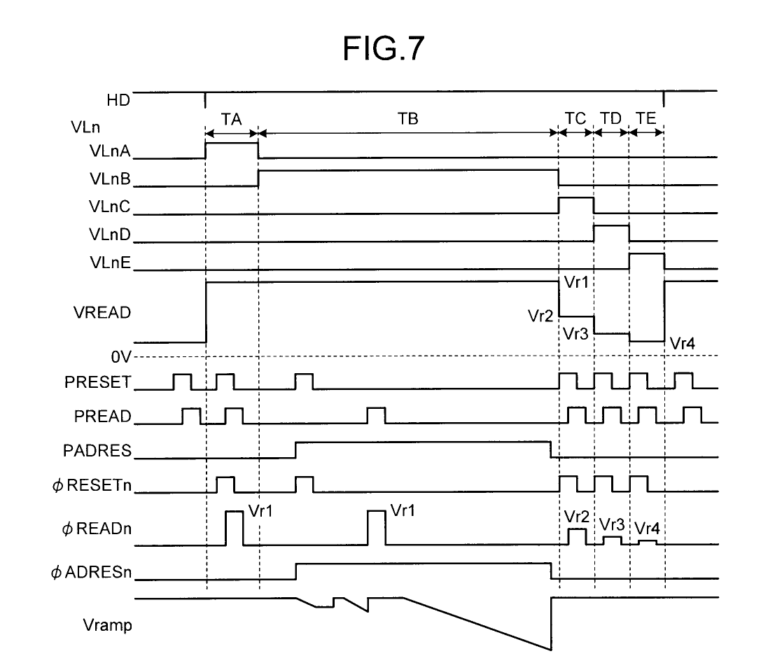

FIG. 7 is a timing chart illustrating signal waveforms of the individual units of the selector 14 and the level shifter 15 of the solid-state imaging device of FIG. 1. The example of FIG. 7 shows a timing chart corresponding to one horizontal period of the pixel array unit 1 of FIG. 1. Also, the example of FIG. 7 shows a signal of the shutter period TA, a signal of the reading period TB, and signals of the individual division periods TC, TD, and TE in one horizontal period. However, actually, the signal of the shutter period TA of FIG. 7 is enabled in the shutter period TA of FIG. 3, the signal of the reading period TB of FIG. 7 is enabled in the reading period TB of FIG. 3, and the signals of the individual division periods TC, TD, and TE of FIG. 7 are enabled in signals of the individual division periods TC, TD, and TE of FIG. 3.

In FIG. 7, as the n-th line designation signal VLn, a line designation signal VLnA is input to the selector 14 in the shutter period TA, a designation signal VLnB is input to the selector 14 in the reading period TB, and designation signals VLnC, VLnD, and VLnE are input to the selector 14 in the individual division periods TC, TD, and TE.

Then, in a case where the row selecting signal ΦADRESn is at a low level, since the row selecting transistor Ta is turned off so as not to perform a source follower operation, any signal is not output to the vertical signal line Vlin. Next, in the shutter period TA, if the reset instruction signal PRESET and the read instruction signal PREAD rise in a state that the line designation signal VLnA has risen, the line designation signal VLnA is output to the buffers B1 and B2 through the AND circuits Nil and N12 of FIG. 5. Then, in the buffers B1 and B2, the level of the line designation signal VLnA is shifted such that the read signal ΦREADn and the reset signal ΦRESETn rise. At this time, the read voltage VREAD is set to Vr1, such that the read signal ΦREADn is set to the read voltage Vr1. Then, if the read signal ΦREADn and the reset signal ΦRESETn rise, the read transistor Td and the reset transistor Tc are turned on, such that the charges accumulated in the photodiode PD are discharged to a power supply VDD through the floating diffusion FD.

After the charges accumulated in the photodiode PD are discharged to the power supply VDD, if the read signal ΦREADn becomes the low level, in the photodiode PD, valid signal charges start to be accumulated.

Next, in the reading period TB, if the row selection instruction signal PADRES rises in a state that the line designation signal VLnB has risen, the line designation signal VLnB is output to the buffer B3 through the AND circuit N13 of FIG. 5. Then, in the buffers B3, the level of the line designation signal VLnB is shifted such that the row selecting signal ΦADRESn rises.

Then, the row selecting signal ΦADRESn rises, the row selecting transistor Ta of each pixel PC is turned on, such that the power supply potential VDD is applied to the drain in the amplifying transistor Tb. As a result, a source follower is configured by the amplifying transistor Tb and the load transistor TL.

At this time, if the reset instruction signal PRESET rises, the line designation signal VLnB is output to the buffer B2 through the AND circuit N12 of FIG. 5. Then, in the buffers B2, the level of the line designation signal VLnB is shifted such that the reset signal ΦRESETn rises. Then, if the reset signal ΦRESETn rises, the reset transistor Tc is turned on such that extra charges generated by a leakage current or the like in the floating diffusion FD are reset. Therefore, a voltage according to the rest level of the floating diffusion FD is applied to the gate of the amplifying transistor Tb. Here, since the source follower is configured by the amplifying transistor Tb and the load transistor TL, the voltage of the vertical signal line Vlin follows the voltage applied to the gate of the amplifying transistor Tb, and an output voltage Vsig of the reset level is output to the vertical signal line Vlin.

Next, in the column ADC circuit 4, as the ramp signal Vramp, a triangular wave is applied, and the output voltage Vsig of the reset level is compared with the level of the ramp signal Vramp. Then, counting down is performed until the output voltage Vsig of the reset level coincides with the level of the ramp signal Vramp, such that the output voltage Vsig of the reset level is digitalized and stored.

Next, if the instruction signal PREAD rises, the line designation signal VLnB is output to the buffer B1 through the AND circuit N11 of FIG. 5. Then, in the buffers B1, the level of the line designation signal VLnB is shifted such that the read signal ΦREADn rises. If the read signal ΦREADn rises, the read transistor Td is turned on so as to transmit the charges accumulated in the photodiode PD, to the floating diffusion FD, and a voltage according to the signal level of the floating diffusion FD is applied to the gate of the amplifying transistor Tb. Here, since the source follower is configured by the amplifying transistor Tb and the load transistor TL, the voltage of the vertical signal line Vlin follows the voltage applied to the gate of the amplifying transistor Tb, and is output as the an output voltage Vsig of the read level to the vertical signal line Vlin.

Next, in the column ADC circuit 4, as the ramp signal Vramp, a triangular wave is applied, and the output voltage Vsig of the read level is compared with the level of the ramp signal Vramp. Then, at this time, counting up is performed until the output voltage Vsig of the read level coincides with the level of the ramp signal Vramp, such that a difference between the output voltage Vsig of the read level and the output voltage Vsig of the reset level is digitalized and is transmitted to the line memory 5.

Next, in the shutter period TC, if the reset instruction signal PRESET and the read instruction signal PREAD rise in a state that the line designation signal VLnC has risen, the line designation signal VLnC is output to the buffers B1 and B2 through the AND circuits N11 and N12 of FIG. 5. Immediately before the read instruction signal PREAD rises, the reset instruction signal PRESET can rise earlier than rising of the read instruction signal PREAD. Then, in the buffers B1 and B2, the level of the line designation signal VLnC is shifted such that the read signal ΦREADn and the reset signal ΦRESETn rise, respectively. At this time, the read voltage VREAD is set to Vr2, such that the read signal ΦREADn is set to the read voltage Vr2. Then, if the read signal ΦREADn and the reset signal ΦRESETn rise, the read transistor Td and the reset transistor Tc are turned on, such that the charges accumulated in the photodiode PD are discharged to a power supply VDD through the floating diffusion FD.

Next, in the shutter period TD, if the reset instruction signal PRESET and the read instruction signal PREAD rise in a state that the line designation signal VLnD has risen, the line designation signal VLnD is output to the buffers B1 and B2 through the AND circuits N11 and N12 of FIG. 5. Then, in the buffers B1 and B2, the level of the line designation signal VLnD is shifted such that the read signal ΦREADn and the reset signal ΦRESETn rise. At this time, the read voltage VREAD is set to Vr3, such that the read signal ΦREADn is set to the read voltage Vr3. Then, if the read signal ΦREADn and the reset signal ΦRESETn rise, the read transistor Td and the reset transistor Tc are turned on, such that the charges accumulated in the photodiode PD are discharged to a power supply VDD through the floating diffusion FD.

Next, in the shutter period TE, if the reset instruction signal PRESET and the read instruction signal PREAD rise in a state that the line designation signal VLnE has risen, the line designation signal VLnE is output to the buffers B1 and B2 through the AND circuits N11 and N12 of FIG. 5. Then, in the buffers R1 and B2, the level of the line designation signal VLnE is shifted such that the read signal ΦREADn and the reset signal ΦRESETn rise. At this time, the read voltage VREAD is set to Vr4, such that the read signal ΦREADn is set to the read voltage Vr4. Then, if the read signal ΦREADn and the reset signal ΦRESETn rise, the read transistor Td and the reset transistor Tc are turned on, such that the charges accumulated in the photodiode PD are discharged to a power supply VDD through the floating diffusion FD.

### Second Embodiment

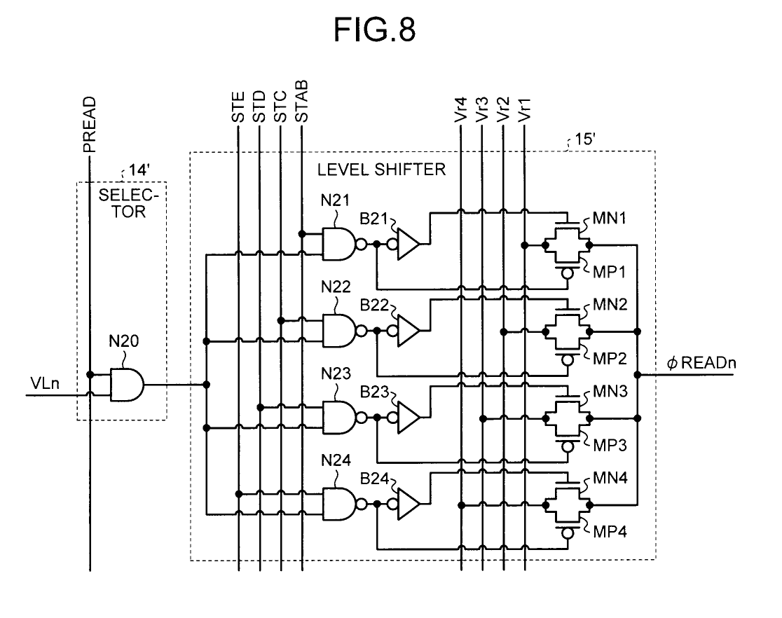

FIG. 8 is a circuit diagram illustrating an example of a configuration of a selector 14′ and a level shifter 15′ of a solid-state imaging device according to a second embodiment. In the example of FIG. 8, the selector 14′ and the level shifter 15′ shows a configuration corresponding to one line of the pixel array unit 1 of FIG. 1. Further, in the example of FIG. 8, the selector 14′ and the level shifter 15′ show a portion corresponding to the read signal ΦREADn, and do not show a portion corresponding to the reset signal ΦRESETn and the row selecting signal ΦADRESn.

In FIG. 8, in the solid-state imaging device, the selector 14′ and the level shifter 15′ are provide in place of the selector 14 and the level shifter 15 of FIG. 5. The selector 14′ includes an AND circuit N20, and the level shifter 15′ includes NAND circuits N21 to N24, inverters B21 to B24, N-channel field effect transistors MN1 to MN4, and P-channel field effect transistors MP1 to MP4.

Then, the read instruction signal PREAD is input to one input terminal of the AND circuit N20, and the line designation signal VLn of the n-th line of the gate latch circuit 13 is input to the other input terminal of the AND circuit N20.

Period selecting signals STAB, STC, STD, and STE are input to one-side input terminals of the NAND circuits N21 to N24, respectively, and an output of the AND circuit N20 are input to the other input terminals of the NAND circuits N21 to N24. The period selecting signal STAB can select the shutter period TA and the reading period TB, and the period selecting signals STC, STD, and STE can select the division periods TC, TD, and TE, respectively.

Further, the N-channel field effect transistor MN1 and the P-channel field effect transistor MP1 are connected in parallel to each other, the N-channel field effect transistor MN2 and the P-channel field effect transistor MP2 are connected in parallel to each other, the N-channel field effect transistor MN3 and the P-channel field effect transistor MP3 are connected in parallel to each other, and the N-channel field effect transistor MN4 and the P-channel field effect transistor MP4 are connected in parallel to each other.

Furthermore, the read voltage Vr1 is input to one connection node of the N-channel field effect transistor MN1 and the P-channel field effect transistor MP1, the read voltage Vr2 is input to one connection node of the N-channel field effect transistor MN2 and the P-channel field effect transistor MP2, the read voltage Vr3 is input to one connection node of the N-channel field effect transistor MN3 and the P-channel field effect transistor MP3, and the read voltage Vr4 is input to one connection node of the N-channel field effect transistor MN4 and the P-channel field effect transistor MP4.

An output of the NAND circuit N21 is input to a gate of the N-channel field effect transistor MN1 through the inverter B21, and the output of the NAND circuit N21 is input to a gate of the P-channel field effect transistor MP1.

An output of the NAND circuit N22 is input to a gate of the N-channel field effect transistor MN2 through the inverter B22, and the output of the NAND circuit N22 is input to a gate of the P-channel field effect transistor MP2.

An output of the NAND circuit N23 is input to a gate of the N-channel field effect transistor MN3 through the inverter B23, and the output of the NAND circuit N23 is input to a gate of the P-channel field effect transistor MP3.

An output of the NAND circuit N24 is input to a gate of the N-channel field effect transistor MN4 through the inverter B24, and the output of the NAND circuit N24 is input to a gate of the P-channel field effect transistor MP4.

Then, if the read instruction signal PREAD rises in a state that the line designation signal VLn has risen, the line designation signal VLn is output to the NAND circuits N21 to N24. Further, in the shutter period TA and the reading period TB, if the period selecting signal STAB rises, the output of the NAND circuit N21 falls, such that the N-channel field effect transistor MN1 and the P-channel field effect transistor MP1 are turned on. Therefore, the read signal ΦREADn is set to the read voltage Vr1.

Also, in the division period TC, if the period selecting signal STC rises, the output of the NAND circuit N22 falls, such that the N-channel field effect transistor MN2 and the P-channel field effect transistor MP2 are turned on. Therefore, the read signal ΦREADn is set to the read voltage Vr2.

Further, in the division period TD, if the period selecting signal STD rises, the output of the NAND circuit N23 falls, such that the N-channel field effect transistor MN3 and the P-channel field effect transistor MP3 are turned on. Therefore, the read signal ΦREADn is set to the read voltage Vr3.

Furthermore, in the division period TE, if the period selecting signal STE rises, the output of the NAND circuit N24 falls, such that the N-channel field effect transistor MN4 and the P-channel field effect transistor MP4 are turned on. Therefore, the read signal ΦREADn is set to the read voltage Vr4.

Here, in the configuration of FIG. 5, in order to change the read signal ΦREADn to the read voltages Vr1 to Vr4, it is necessary to change the level of the read voltage VREAD in a stepwise shape; however, in the configuration of FIG. 8, it is possible change the level of the read signal ΦREADn using the fixed read voltages Vr1 to Vr4.

### Third Embodiment

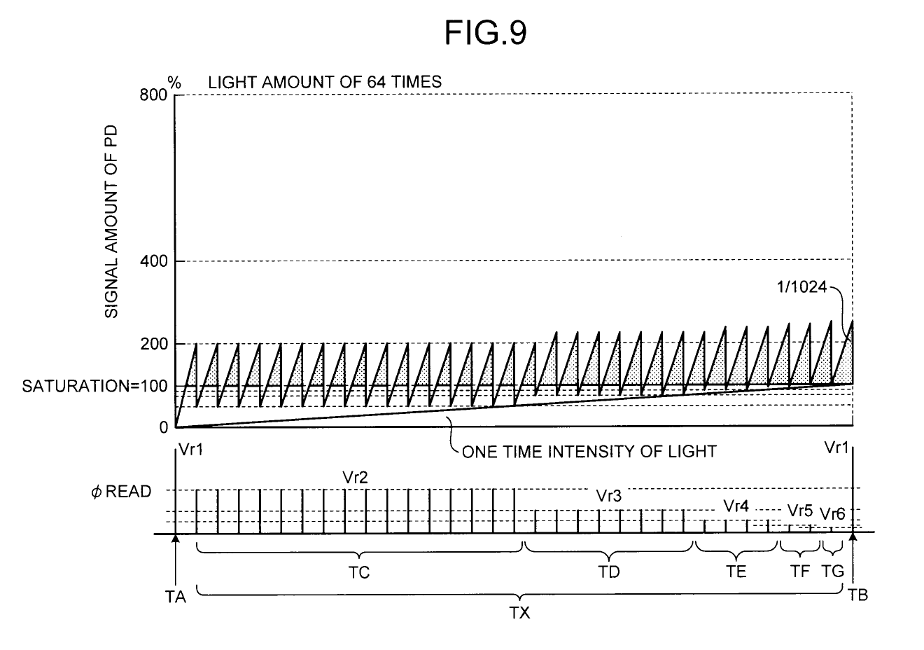

FIG. 9 is a timing chart illustrating a relation between an application timing of a read signal and a signal amount of a photodiode of a solid-state imaging device according to a third embodiment.

Referring to FIG. 9, in the present embodiment, the accumulating period TX is divided into division periods TC, TD, TE, TF, and TG by the ½, ¼, ⅛ and 1/16 points of the accumulating period TX. In other words, the division period TC can be a period until the ½ point of the accumulating period TX, the division period TD can be a period from the ½ point to ¾ point of the accumulating period TX, the division period TE can be a period from the ¾ point to ⅞ point of the accumulating period TX, the division period TF can be a period from the ⅞ point to 15/16 point of the accumulating period TX, and the division period TG can be a period from the 15/16 point to 31/32 point of the accumulating period TX.

At this time, in the division period TC, the read voltage of the read signal ΦREADn is set to Vr2, and in the division period TD, the read voltage of the read signal ΦREADn is set to Vr3, and in the division period TE, the read voltage of the read signal ΦREADn is set to Vr4, and in the division period TF, the read voltage of the read signal ΦREADn is set to Vr5, and in the division period TG, the read voltage of the read signal ΦREADn is set to Vr6.

The read voltage Vr2 can be set as a voltage to read a signal of about 50% or less of saturation from the photodiode PD. The read voltage Vr3 can be set as a voltage to read a signal of about 25% or less of saturation from the photodiode PD. The read voltage Vr4 can be set as a voltage to read a signal of about 12.5% or less of saturation from the photodiode PD. The read voltage Vr5 can be set as a voltage to read a signal of about 6.5% or less of saturation from the photodiode PD. The read voltage Vr6 can be set as a voltage to read a signal of about 3.125% or less of saturation from the photodiode PD.

For example, if the levels of read signals of the shutter period TA and the reading period TB are set to 3 V, the level of the read signal of the division period TC can be set to 2 V, the level of the read signal of the division period TD can be set to 1.5 V, the level of the read signal of the division period TE can be set to 1 V, the level of the read signal of the division period TF can be set to 0.5 V, and the level of the read signal of the division period TG can be set to 0.25 V.

For example, in the division period TC, the read voltage Vr2 can be collectively applied to 16 lines, and in the division period TD, the read voltage Vr3 can be collectively applied to 8 lines, and in the division period TE, the read voltage Vr4 can be collectively applied to 4 lines, and in the division period TF, the read voltage Vr5 can be collectively applied to 2 lines, and in the division period TG, the read voltage Vr6 can be applied to 1 line.

Accordingly, it is possible to discharge signal charges of the saturation signal or greater from each pixel PC a plurality of times during the accumulating period TX, and only a signal of a triangular gray portion after the division period TG becomes a blooming amount. Therefore, it is possible to reduce the blooming amount to about 1/1024 as compared to a case where excessive charges are not discharged from the pixels PC in the accumulating period TX, and, for example, it is possible to reduce the excessive signal charges spread in 1024 pixels, to signal charges corresponding to one pixel. In order to further reduce the blooming amount, it is possible to further increase the division number of the accumulating period TX.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit that includes pixels configured to accumulate photo-electric converted charges and disposed in a matrix; and
a vertical drive circuit that drives the pixels for a plurality of lines collectively in an accumulating period of each pixel, thereby discharging charges at a predetermined level or higher from the pixels.

2. The solid-state imaging device according to claim 1,
wherein the vertical drive circuit drives the pixels for each line in a reading period of the pixels, thereby overall charges accumulated in the pixels are read.

3. The solid-state imaging device according to claim 1,
wherein the vertical drive circuit applies a read signal a plurality of times in an accumulating period, the read signal having a level lower than a read signal that is applied in the reading period of the pixels.

4. The solid-state imaging device according to claim 3,
wherein the vertical drive circuit decreases the level of the read signal as the accumulating period shortens.

5. The solid-state imaging device according to claim 4,
wherein the vertical drive circuit decreases the level of the read signal at the ½ and ¼ points of the accumulating period.

6. The solid-state imaging device according to claim 1,
wherein the vertical drive circuit includes
a decoder circuit that designates a selection row of the pixel array unit for each line,
a decoder control circuit that controls a row selecting timing of the decoder circuit,
a first latch circuit that stores data of the selection row designated by the decoder circuit,
a second latch circuit that collectively stores the data of the selection row stored in the first latch circuit for each line,
a selector that selects a signal to drive the pixels, and
a level shifter that controls an output level of the signal to drive the pixels.

7. The solid-state imaging device according to claim 6, further comprising:
a first gate circuit that controls a timing at which the data of the selection row designated by the decoder circuit is output to the first latch circuit; and
a second gate circuit that controls a timing at which the data of the selection row stored in the first latch is output to the second latch circuit.

8. The solid-state imaging device according to claim 7,
wherein the decoder control circuit includes a multi-counter provided with a plurality of sub-counters.

9. The solid-state imaging device according to claim 8,
wherein the decoder control circuit includes a switching unit that switches the counter based on a control signal to divide a horizontal scanning period.

10. The solid-state imaging device according to claim 9,
wherein one horizontal scanning period includes a shutter period, a reading period, and an accumulating period.

11. The solid-state imaging device according to claim 10,
wherein the accumulating period includes a plurality of division periods.

12. The solid-state imaging device according to claim 11,
wherein the division periods are divided into a plurality of fine division periods.

13. The solid-state imaging device according to claim 12,
wherein the sub-counters output count values to the decoder circuit for each of the shutter period, the reading period, and the fine division periods.

14. The solid-state imaging device according to claim 13,
wherein the first latch circuit and the second latch circuit are provided for each line.

15. The solid-state imaging device according to claim 14,
wherein one line of a selection row is designated by the count values of the fine division periods, and a value of the selection row is stored in the first latch circuit.

16. The solid-state imaging device according to claim 15,
wherein values of a plurality of selection rows stored in a time division manner in the first latch circuit are collectively stored in the second latch circuit.

17. The solid-state imaging device according to claim 16,
wherein charges of pixels of a plurality of lines, designated by the selection rows, stored in the second latch circuit are collectively discharged in the division periods.

18. The solid-state imaging device according to claim 6,
wherein the level shifter decreases the level of the read signal in a stepwise shape.

19. The solid-state imaging device according to claim 6,
wherein the level shifter includes a multiplexer that selectively switches a plurality of voltage signals having different levels.

20. The solid-state imaging device according to claim 6,
wherein each of the pixels includes
a photodiode that performs photo-electric conversion,
a read transistor that transmits a signal from the photodiode to floating diffusion,
a reset transistor that resets the signal accumulated in the floating diffusion, and
an amplifying transistor that detects a potential of the floating diffusion.
